(19) United States
(12) Patent Application Publication
(10) Pub. No.: US 2023/0134956 A1
(43) Pub. Date: May 4, 2023

(54) MULTIPURPOSE INTERLOCKABLE BOARD SYSTEM

(71) Applicant: Irving Licensing Inc., Saint John (CA)

(72) Inventor: Philippe Mathieu Martin, Saint John (CA)

(21) Appl. No.: 17/978,375

(22) Filed: Nov. 1, 2022

Related U.S. Application Data
(60) Provisional application No. 63/275,509, filed on Nov. 4, 2021.

(51) Int. Cl. B32B 3/06; B32B 21/13; B32B 21/14; B32B 38/00

(52) U.S. Cl. CPC B32B 3/06; B32B 21/13; B32B 21/14; B32B 38/0004; B32B 2317/16

(57) ABSTRACT

A multipurpose interlockable board system comprising a plurality of identical boards interlockable in a coplanar arrangement in which laterally adjacent boards are generally coplanar for selectively forming a flat covering and in an orthogonal arrangement in which laterally adjacent boards are generally perpendicular for selectively forming a hollow section, and the boards interlockable end-to-end to lengthen the flat covering and the hollow section selectively formed by the boards.

### CROSS-REFERENCE TO RELATED APPLICATIONS

The present application claims the benefit of priority from U.S. Provisional Application No. 63/275,509, filed Nov. 4, 2021, which is hereby incorporated herein by reference in its entirety.

### FIELD

The specification relates generally to a multipurpose interlockable board system for use in general construction.

### BACKGROUND

U.S. Pat. No. 6,519,912 (Eckmann et al.) discloses a converted wood article for use in combination with other converted wood articles to form composite wood products for use in general construction such as in the construction of posts, flooring, walls, and support beams. Converted wood articles preferably include engaging surfaces and in composite wood products formed therefrom include joints between engaging surfaces which are displaced from the outer corners of the composite wood product. Adjacent engaging surfaces forming a joint include correspondingly shaped inter-engaging portions.

U.S. Pat. No. 5,870,876 (Deiter) discloses a converted wood article for use in combination with other converted wood articles to form composite wood products for use in the construction of posts, flooring, walls, and support beams.

U.S. Pat. No. 9,682,492 (Schaffter) discloses a woodworking jig used to set cutter height and horizontal fence position when forming lock miter joints with a forty-five degree lock miter cutter on a router table or shaper.

### SUMMARY

The following summary is intended to introduce the reader to various aspects of the applicant's teaching, but not to define any invention.

According to some aspects, a multipurpose interlockable board system comprises a plurality of identical interlockable boards. Each board includes: (a) a board first face and a board second face parallel to the board first face and spaced apart from the board first face by a board thickness. The board first and second faces extend axially along a board axis between first and second end edges of the board and extend laterally between first and second side edges of the board. Each board further includes: (b) an interlockable first side joint profile extending along the first side edge; and (c) an interlockable second side joint profile extending along the second side edge. Each of the first and second side joint profiles of each board is interlockable with each of the first and second side joint profiles of another board for interlocking laterally adjacent boards in a coplanar arrangement in which the boards are generally coplanar for selectively forming a flat covering, and in an orthogonal arrangement in which laterally adjacent boards are generally perpendicular for selectively forming a hollow section. Each board further includes (d) an interlockable first end joint profile extending along the first end edge; and (e) an interlockable second end joint profile extending along the second end edge. The second end joint profile of each board is interlockable with the first end joint profile of another board for interlocking axially adjacent boards end-to-end to lengthen the flat covering and the hollow section selectively formed by the boards.

In some examples, the board has four corners where corresponding end joint profiles and edge joint profiles intersect.

In some examples, each of the first and second end joint profiles extends generally continuously from the first side edge to the second side edge of the board, and each of the first and second side joint profiles extends generally continuously from the first end edge to the second end edge of the board.

In some examples, each board is of integral, unitary, one-piece construction.

In some examples, the board is made of solid wood, and each of the first and second side joint profiles and the first and second end joint profiles are cut into the solid wood.

In some examples, the first end joint profile comprises an end groove extending axially into the first end edge and laterally between the first and second side edges, and the second end joint profile comprises an end tongue projecting axially from the second end edge and extending laterally between the first and second side edges.

In some examples, the end groove is disposed orthogonally between a pair of axially extending first and second flanges. The first flange has a first flange outer surface defined by part of the board first face and a first flange inner surface opposite the first flange, and the second flange has a second flange outer surface defined by part of the board second face and a second flange inner surface opposite the second flange outer surface and facing the first flange inner surface. The end groove is bounded orthogonally by the first and second flange inner surfaces.

In some examples, the second end joint profile includes a first end recess adjacent the end tongue and open orthogonally to the first face and a second end recess adjacent the end tongue opposite the first end recess and open orthogonally to the board second face. When axially adjacent boards are interlocked end-to-end, the first and second end recesses of one board of the axially adjacent boards receive the first and second flanges, respectively, of another board of the axially adjacent boards.

In some examples, the laterally adjacent boards are interlockable in a first side-by-side coplanar arrangement along respective first sides thereof by interlocking together the first side joint profiles of each board of the laterally adjacent boards, and are interlockable in a second side-by-side coplanar arrangement along respective second sides thereof by interlocking together the second side joint profiles of each board of the laterally adjacent boards.

In some examples, the laterally adjacent boards are interlockable in the orthogonal arrangement along respective sides thereof by interlocking together the first side joint profile of one board of the laterally adjacent boards with the second side joint profile of another board of the laterally adjacent boards.

In some examples, the first side joint profile defines a first lock miter profile and the second side joint profile defines a second lock miter profile. The first and second lock miter profiles correspond in shape and size for interlocking thereof and are oriented perpendicular to each other.

In some examples, each of the first side joint profile and the second side joint profile comprises a 45-degree bevel surface sloping laterally inwardly from the second face to the first face, a side groove in the bevel surface, and a side tongue adjoining the side groove and projecting from the bevel surface. The side tongue and groove of the first side joint profile are oriented parallel to the first and second faces, and the side tongue and groove of the second side joint profile are oriented perpendicular to the first and second faces, and each side tongue and groove of the board is interlockable with each side tongue and groove of another board.

In some examples, the first side joint profile comprises a first side groove disposed between a laterally protruding side flange and a laterally protruding first side tongue. The side flange has a side flange outer surface defined by part of the board second face and a side flange inner surface orthogonally opposite the side flange outer surface and bounding the first side groove, and the first side tongue protrudes laterally outwardly and is disposed orthogonally intermediate the first side groove and the board first face. Laterally adjacent boards are interlockable in a first side-by-side coplanar arrangement, in which the first side tongue of each board of the laterally adjacent boards is received in a corresponding first side groove of another board of the laterally adjacent boards.

In some examples, the first side joint profile includes a side recess adjacent the first side tongue opposite the first side groove and open orthogonally to the board first face, and when laterally adjacent boards are interlocked in the first side-by-side coplanar arrangement, the side flange of each board of the laterally adjacent boards is received in a corresponding side recess of another board of the laterally adjacent boards.

In some examples, the second side joint profile comprises a second side groove open orthogonally to the first face and a second side tongue laterally outboard of the first side groove and projecting orthogonally toward the first face, and laterally adjacent boards are interlockable in a second side-by-side coplanar arrangement, in which the second side tongue of each board of the laterally adjacent boards is received in a corresponding second side groove of another board of the laterally adjacent boards.

In some examples, when laterally adjacent boards are interlocked in the orthogonal arrangement, the first side tongue of a first board of the laterally adjacent boards is received in the second side groove of a second board of the laterally adjacent boards, and the second side tongue of the second board is received in the first side groove of the first board.

According to some aspects, a multipurpose interlockable board system includes a plurality of identical boards interlockable in a coplanar arrangement in which laterally adjacent boards are generally coplanar for selectively forming a flat covering and in an orthogonal arrangement in which laterally adjacent boards are generally perpendicular for selectively forming a hollow section. The boards are interlockable end-to-end to lengthen the flat covering and the hollow section selectively formed by the boards.

In some examples, each board has interlockable side joint profiles along laterally opposing edges of the board for interlocking the boards in the coplanar arrangement and in the orthogonal arrangement, and interlockable end joint profiles along axially opposite ends of the board for interlocking the boards end-to-end.

In some examples, the boards are made entirely of solid wood, and wherein the side joint profiles and the end joint profiles are cut into the solid wood.

According to some aspects, a method of manufacturing an interlockable board for a multipurpose interlockable board system includes: (a) cutting a first side joint profile along a first side edge of the board and a complementary second side joint profile along a second side edge of the board laterally opposite the first side edge. Each of the first and second side joint profiles of the board interlockable with each of the first and second side joint profiles of another board for interlocking laterally adjacent boards in a coplanar arrangement in which the boards are generally coplanar for selectively forming a flat covering, and in an orthogonal arrangement in which laterally adjacent boards are generally perpendicular for selectively forming a hollow section. The method further includes: (b) cutting a first end joint profile along a first end edge of the board and a complementary second end edge joint profile along a second end edge of the board axially opposite the first end edge. The second end joint profile of the board is interlockable with the first end joint profile of another identical board for interlocking axially adjacent boards end-to-end to lengthen the flat covering and the hollow section selectively formed by the boards. In some examples, (a) is performed prior to (b). In some examples, (b) includes cutting through end portions of the first side joint profile and of the second side joint profile formed in (a).

### BRIEF DESCRIPTION OF THE DRAWINGS

The drawings included herewith are for illustrating various examples of articles, systems, and methods of the present specification and are not intended to limit the scope of what is taught in any way. In the drawings:

FIG. 1 is a plan view of an example interlockable board system in a coplanar arrangement;

FIG. 2 is a perspective view of the interlockable board system of FIG. 1 in an orthogonal arrangement;

FIG. 3 is a perspective view from a first end of an example board of the board system of FIG. 1;

FIG. 4 is an end view from a second end of the board of FIG. 3;

FIG. 5 is a side view from a first side of end portions of the board of FIG. 3;

FIG. 6 is an end view of the board system in the coplanar arrangement shown in FIG. 1;

FIG. 6A is an enlarged view of interlocked first side edge portions of a pair of boards of the board system of FIG. 6;

FIG. 6B is an enlarged view of interlocked second side edge portions of another pair of boards of the board system FIG. 6;

FIG. 7 is an end view of the board system in the orthogonal arrangement shown in FIG. 2;

FIG. 7A is an enlarged view of a corner of the board system shown in FIG. 7, showing interlocked edge portions of a pair of the boards of the board system shown in FIG. 7;

FIG. 8 is an enlarged side view of interlocked end portions of a pair of the boards of the board system of FIG. 1;

FIG. 9 is a perspective view of a first corner of the board of FIG. 3;

FIG. 10 is a perspective view of a second corner of the board of FIG. 3;

FIG. 11 is a perspective view of a third corner of the board of FIG. 3;

FIG. 12 is a perspective view of a fourth corner of the board of FIG. 3;

FIG. 13 is a perspective view of another example board for an interlockable board system; and

FIG. 14 is an end view of the board of FIG. 13.

### DETAILED DESCRIPTION

Various articles, systems, or processes will be described below to provide an example of an embodiment of each claimed invention. No embodiment described below limits any claimed invention and any claimed invention may cover articles, systems, or processes that differ from those described below. The claimed inventions are not limited to articles, systems, or processes having all of the features of any one article, system, or process described below or to features common to multiple or all of the articles, systems, or processes described below. It is possible that an article, system, or process described below is not an embodiment of any claimed invention. Any invention disclosed in an article, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

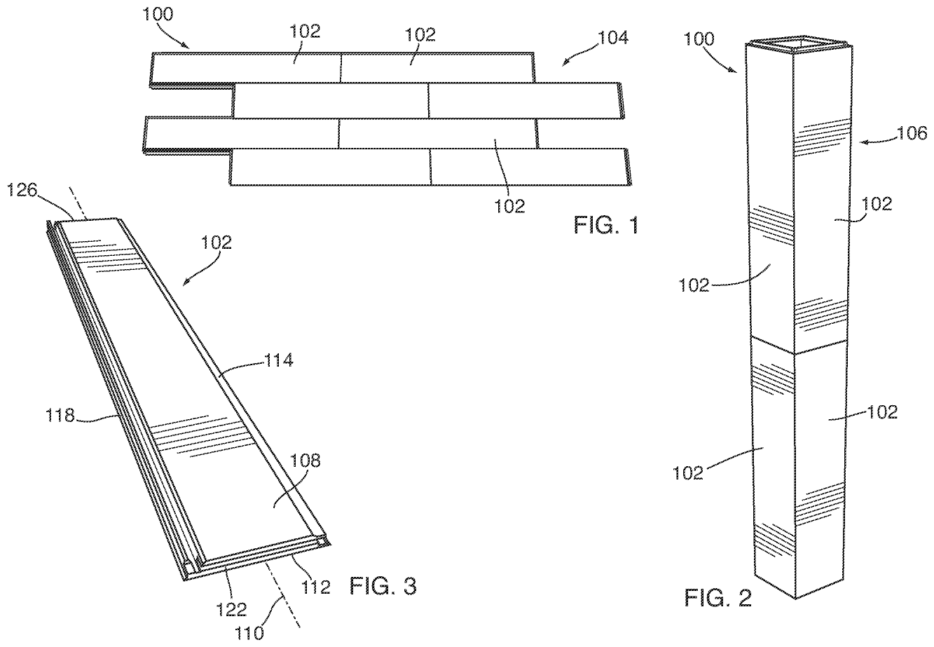

Referring to FIGS. 1 and 2, an example multipurpose interlockable board system 100 is shown. The board system 100 includes a plurality of identical interlockable boards 102 interlockable in a coplanar arrangement (shown in FIG. 1) and in a orthogonal arrangement (shown in FIG. 2). Referring to FIG. 1, when in the coplanar arrangement, laterally adjacent boards 102 are generally coplanar for selectively forming a flat covering 104. The flat covering 104 can be used as, for example, a wall or floor covering. Referring to FIG. 2, when in the orthogonal arrangement, laterally adjacent boards 102 are perpendicular to each other for selectively forming a hollow section 106. The hollow section 106 shown in FIG. 2 is formed from four boards 102 and has a square cross-section in the example illustrated. The hollow section 106 can be used as, for example, a column (e.g. a post covering for a structural post) or beam (e.g. a decorative ceiling beam). The boards 102 are interlockable end-to-end to lengthen the flat covering 104 and the hollow section 106 selectively formed by the boards to a desired length.

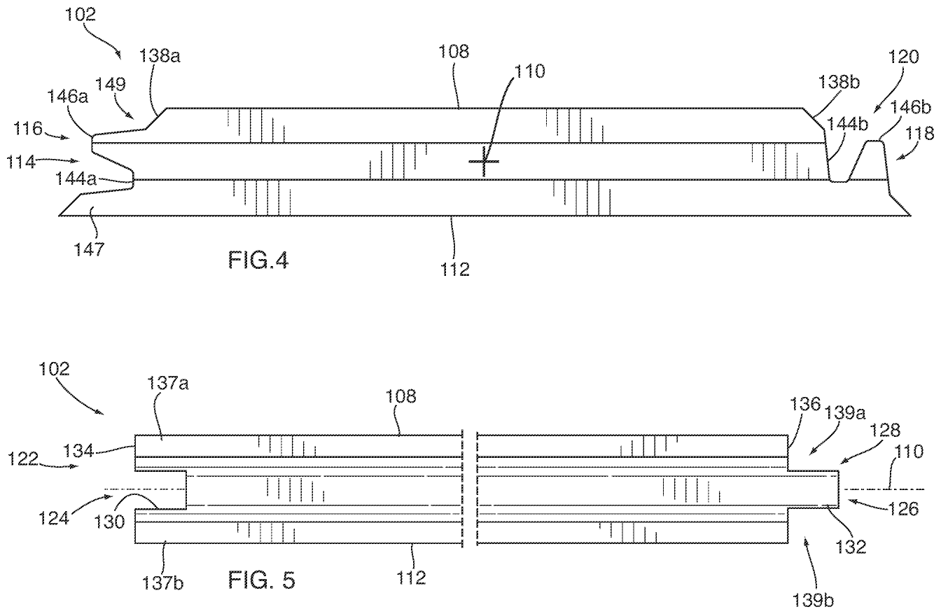

Referring to FIG. 3, each board 102 has a board first face 108 and a board second face 112 spaced orthogonally apart from the board first face 108 by a board thickness. The board first and second faces 108, 112 extend axially along a board axis 110 between first and second end edges 122, 126. The board first and second faces 108, 112 extend laterally between first and second side edges 114, 118. Referring to FIG. 4, in the example illustrated, an interlockable first side joint profile 116 extends along the first side edge 114 and an interlockable second side joint profile 120 extends along the second side edge 118. Each of the first and second side joint profiles 116, 120 of each board 102 is interlockable with each of the first and second side joint profiles 116, 120 of another board 102 for interlocking laterally adjacent boards 102 in the coplanar arrangement and in the orthogonal arrangement.

Referring to FIG. 5, in the example illustrated, an interlockable first end joint profile 124 extends along the first end edge 122 of the board 102 and an interlockable second end joint profile 128 extends along the second end edge 126 of the board 102. The second end joint profile 128 of each board 102 is interlockable with the first end joint profile 124 of another board 102 for interlocking axially adjacent boards 102 end-to-end to lengthen the flat covering 104 and the hollow section 106 selectively formed by the boards 102.

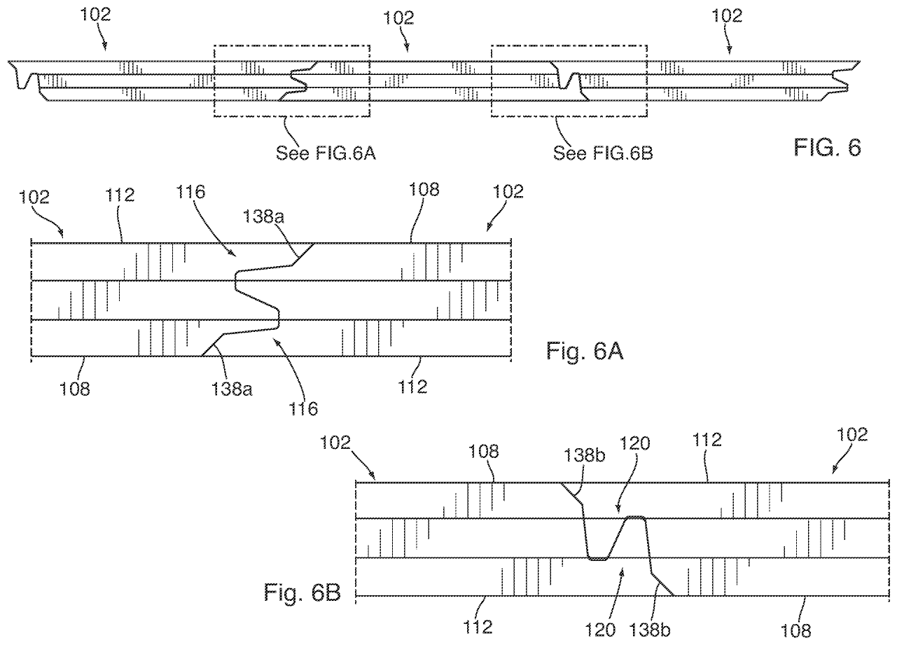

Referring to FIG. 6A, in the example illustrated, laterally adjacent boards 102 are interlockable in a first side-by-side coplanar arrangement (shown in FIG. 6A) along respective first sides thereof by interlocking together the first side joint profiles 116 of each board 102 of the laterally adjacent boards 102. Referring to FIG. 6B, in the example illustrated, laterally adjacent boards 102 are interlockable in a second side-by-side coplanar arrangement (shown in FIG. 6B) along respective second sides thereof by interlocking together the second side joint profiles 120 of each board 102 of the laterally adjacent boards 102. In the example illustrated, when in either coplanar arrangement, the first face 108 of a first board 102 of the laterally adjacent (and interlocked) boards 102 is generally coplanar with the second face 112 of a second board of the laterally adjacent boards 102, and the first face 108 of the second board 102 is generally coplanar with the second face 112 of the first board 102.

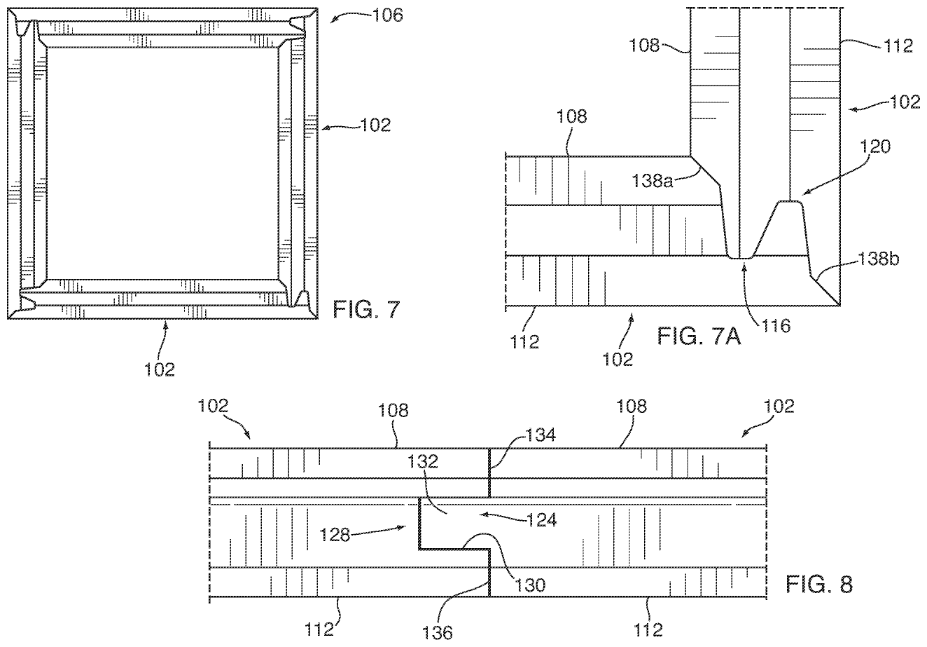

Referring to FIG. 7A, in the example illustrated, laterally adjacent boards 102 are interlockable in the orthogonal arrangement along respective sides thereof by interlocking together the first side joint profile 116 of one board 102 of the laterally adjacent boards 102 with the second side joint profile 120 of another board 102 of the laterally adjacent boards 102. In the example illustrated, when in the orthogonal arrangement, the first faces 108 of the laterally adjacent boards 102 are perpendicular and generally adjoin each other at a corresponding interior corner of the hollow section formed by the laterally adjacent boards 102, and the second faces 112 of the boards 102 are perpendicular and generally adjoin each other at corresponding exterior corner of the hollow section formed by the adjacent boards 102.

Referring to FIG. 8, axially adjacent boards 102 are interlockable end-to-end along respective ends thereof by interlocking together the first end joint profile 124 of one board 102 of the axially adjacent boards 102 with the second end joint profile 128 of another board 102 of the axially adjacent boards 102. In the example illustrated, when axially adjacent boards 102 are interlocked end-to-end, the first faces 108 of the axially adjacent boards 102 are generally coplanar with each other and the second faces 112 of the axially adjacent boards 102 are generally coplanar with each other.

Referring to FIG. 5, in the example illustrated, the first end joint profile 124 comprises an end groove 130 extending axially into the first end edge 122 and laterally between the first and second side edges 114, 118. The second end joint profile 128 comprises an end tongue 132 projecting axially from the second end edge 126 and extending laterally between the first and second side edges 114, 118. Referring to FIG. 8, when axially adjacent boards 102 are interlocked end-to-end, the end tongue 132 of one board 102 of the axially adjacent boards 102 is received in the end groove 130 of another board 102 of the axially adjacent boards 102.

Referring to FIG. 5, in the example illustrated, the first end edge 122 has a first end surface 134 extending orthogonally between the first and second faces 108, 112 and laterally between the first and second side edges 114, 118, and the second end edge 126 has a second end surface 136 extending orthogonally between the first and second faces 108, 112 and laterally between the first and second side edges 114, 118. The end groove 130 extends axially into the first end surface 134 along the board axis 110, and the end tongue 132 projects axially from the second end surface 136. In the example illustrated, the first and second end surfaces 134, 136 are generally perpendicular to the first and second faces 108, 112 and the first and second side edge 114, 118. Referring to FIG. 8, in the example illustrated, when axially adjacent boards 102 are interlocked end-to-end, the first end surface 134 of one board 102 of the axially adjacent boards 102 axially abuts the second end surface 136 of another board 102 of the axially adjacent boards 102.

In the example illustrated, the end tongue 132 and the end groove 130 are generally centered between the first and second faces 108, 112. In the example illustrated, the end groove 130 is spaced orthogonally apart from the board first face 108 by a first portion of the first end surface 134 and is spaced orthogonally apart from the board second face 112 by a second portion of the first end surface 134. In the example illustrated the first and second portions of the first end surface 134 have a generally equal width (measured orthogonal to the first and second board faces 108, 112). In the example illustrated, the end tongue 132 is spaced orthogonally apart from the board first face 108 by a first portion of the second end surface 136 and is spaced orthogonally apart from the board second face 112 by a second portion of the second end surface 136. In the example illustrated the first and second portions of the second end surface 136 have a generally equal width (measured orthogonal to the first and second board faces 108, 112).

Referring to FIG. 5, in the example illustrated, the end groove 130 is disposed orthogonally between a pair of axially extending first and second flanges 137a, 137b. The first flange 137a has a first flange outer surface defined by part of the board first face 108 and a first flange inner surface orthogonally opposite the first flange outer surface. The second flange 137b has a second flange outer surface defined by part of the board second face 112 and a second flange inner surface opposite the second flange outer surface and facing the first flange inner surface. The end groove 130 is bounded orthogonally by the first and second flange inner surfaces. The first and second flanges 137a, 137b have axial endfaces together defining the first end surface 134.

In the example illustrated, the second end joint profile 128 includes a first end recess 139a adjacent the end tongue and open orthogonally to the board first face 108 and a second end recess 139b adjacent the end tongue orthogonally opposite the first end recess 139a and open orthogonally to the board second face 112. In the example illustrated, the second end surface 136 defines an axial boundary of the first and second end recesses 139a, 139b. When axially adjacent boards 102 are interlocked end-to-end, the first and second end recesses 139a, 139b of one board 102 of the axially adjacent boards 102 receive the first and second flanges 137a, 137b of another board of the axially adjacent boards 102.

Referring to FIG. 4, in the example illustrated, the first side joint profile 116 defines a first lock miter profile and the second side joint profile 120 defines a second lock miter profile. The first and second lock miter profiles correspond in shape and size to each other for interlocking thereof and are oriented perpendicular to each other to facilitate interlocking of the boards 102 in the coplanar arrangement and the orthogonal arrangement.

In the example illustrated, the first side joint profile 116 comprises a 45-degree first bevel surface 138a sloping laterally inwardly from the second face 112 to the first face 108, a first side groove 144a in the first bevel surface 138a, and a first side tongue 146a adjoining the first side groove 144a and projecting from the first bevel surface 138a. In the example illustrated, the first side tongue and groove 144a, 146a of the first side joint profile 116 are oriented parallel to the first and second faces 108, 112, with the first side tongue 146a protruding laterally and the first side groove 144a open to a first side of the board 102. In the example illustrated, the first side tongue 146a is between the first face 108 and the first side groove 144a. In the example illustrated, the first side tongue 146a is spaced orthogonally apart from the board first face 108 by a first portion of the first bevel surface 138a, and the first side groove 144a is spaced orthogonally apart from the board second face 112 by a second portion of the first bevel surface 138a. The first and second portions of the first bevel surface 138a are generally equal in width (measured along the bevel surface 138a perpendicular to the board axis 110). In the example illustrated, when the board 102 is viewed from the end edge (122 or 126), the innermost end of the first side groove 144a and the tip of the first side tongue 146a are generally planar.

The second side joint profile 120 comprises a 45-degree second bevel surface 138b sloping laterally inwardly from the second face 112 to the first face 108, a second side groove 144b in the second bevel surface 138b, and a second side tongue 146b adjoining the second side groove 144b and projecting from the second bevel surface 138b. In the example illustrated, the second side tongue and groove 144b, 146b of the second side joint profile 120 are oriented orthogonal to the first and second faces 108, 112, with the second side groove 144b open orthogonally to the first face and the second side tongue 146b protruding orthogonally toward the first face 108. In the example illustrated, the second side groove 144b is between the first face 108 and the second side tongue 146b. In the example illustrated, the second side groove 144b is spaced orthogonally apart from the board first face 112 by a first portion of the second bevel surface 138b, and the second side tongue 146b is spaced orthogonally apart from the board second face 112 by a second portion of the second bevel surface 138b. The first and second portions of the second bevel surface 138b are generally equal in width (measured along the bevel surface 138a perpendicular to the board axis 110). In the example illustrated, when the board 102 is viewed from the end edge (122 or 126), the innermost end of the second side groove 144b and the tip of the second side tongue 146b are generally planar.

In the example illustrated, laterally adjacent boards 102 are interlockable in the first side-by-side coplanar arrangement by interlocking the first side tongue and groove 144a, 146a of one board 102 of the laterally adjacent boards 102 with the first side tongue and groove 144a, 146a of another board 102 of the laterally adjacent boards 102 (with the first bevel surfaces 138a of the boards 102 generally abutting). Laterally adjacent boards 102 are interlockable in the second side-by-side coplanar arrangement by interlocking the second side tongue and groove 144b, 146b of one board 102 of the laterally adjacent boards 102 with the second side tongue and groove 144b, 146b of another board 102 of the laterally adjacent boards 102 (with the second bevel surfaces 138b of the boards 102 generally abutting). Laterally adjacent boards 102 are interlockable in the orthogonal arrangement by interlocking the first side tongue and groove 144a, 146a of one board 102 of the laterally adjacent boards 102 with the second side tongue and groove 144b, 146b of another board 102 of the laterally adjacent boards 102 (with the first bevel surface 138a of the one board 102 abutting the second bevel surface 138b of the other board 102).

Referring to FIG. 4, in the example illustrated, the first side groove 144a is disposed between a laterally protruding side flange 147 and the first side tongue 146a. The side flange 147 has a side flange outer surface defined by part of the board second face 112 and a side flange inner surface orthogonally opposite the side flange outer surface and bounding the first side groove 144a. The first side tongue 146a protrudes laterally outwardly and is disposed orthogonally intermediate the first side groove 144a and the board first face 108. The first side joint profile 116 includes a side recess 149 adjacent the first side tongue 146a opposite the first side groove 144a and open orthogonally to the board first face 108.

When laterally adjacent boards 102 are interlocked in the first side-by-side coplanar arrangement, each first side tongue 146a is received in a corresponding first side groove 144a and each side flange 147 is received in a corresponding side recess 149. When laterally adjacent boards 102 are interlocked in the second side-by-side coplanar arrangement, each second side tongue 146b is received in a corresponding second side groove 144b. When laterally adjacent boards 102 are interlocked in the orthogonal arrangement, the first side tongue 146a of a first board 102 is received in the second side groove 144b of a second board 102, and the second side tongue 146b of the second board 102 is received in the first side groove 144a of the first board 102.

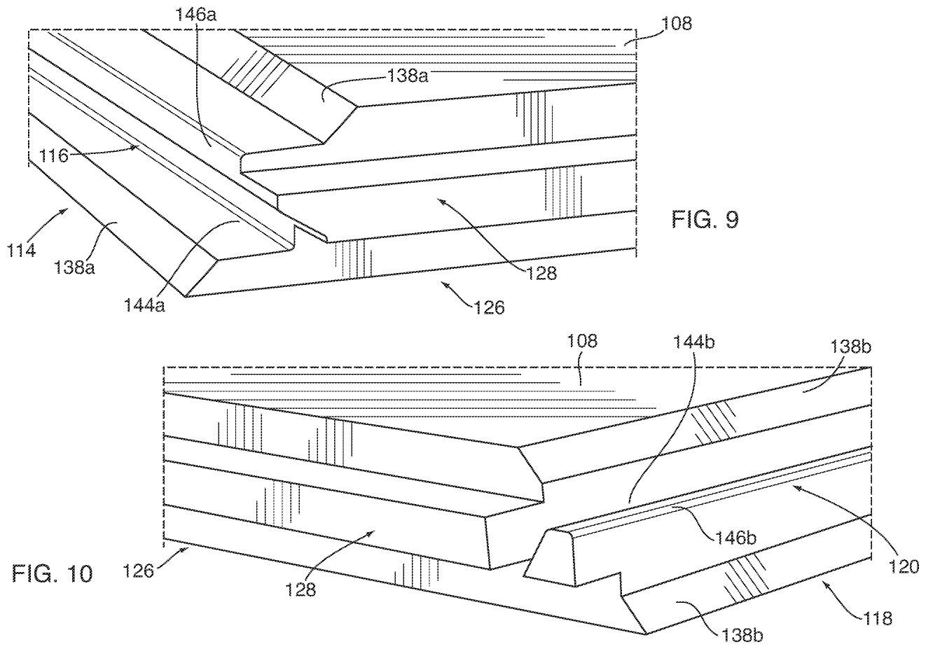

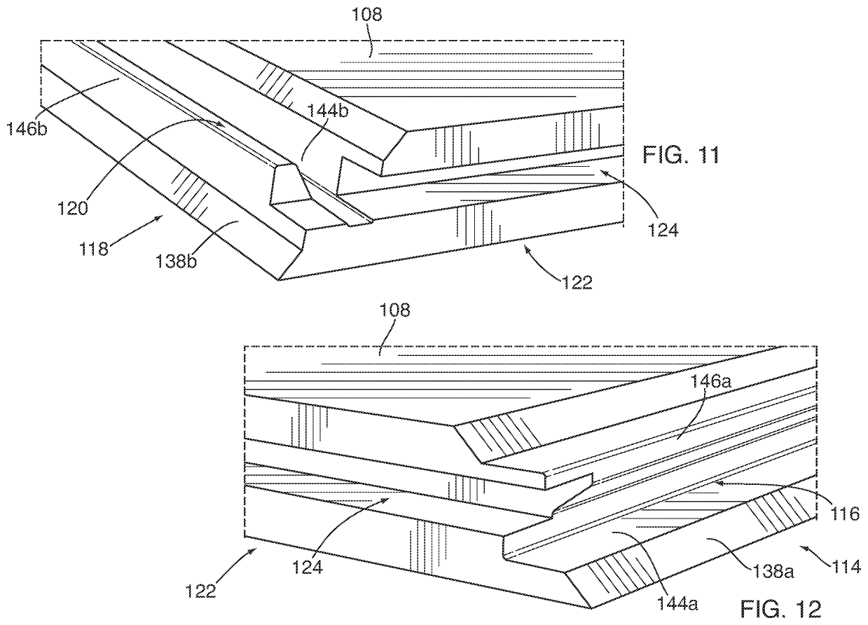

In the example illustrated, each board 102 is of integral, unitary, one-piece construction. In the example illustrated, each board 102 is made of solid wood, and each of the first and second side joint profiles 116, 120 and the first and second end joint profiles 124, 128 are cut into the solid wood. Referring to FIGS. 9 to 12, each of the first and second end joint profiles 124, 128 extends generally continuously from the first side edge 114 to the second side edge 118 of the board 102, and each of the first and second side joint profiles 116, 120 extends generally continuously from the first end edge 122 to the second end edge 126 of the board 102. In the example illustrated, each board 102 has four corners where corresponding end joint profiles 124, 128 and side joint profiles 116, 120 intersect. In the example illustrated, the end groove 130 is laterally open to laterally opposite sides of the board 102, and each of the first and second side grooves 144a, 144b is axially open to axially opposite ends of the board 102. In the example illustrated, the end groove 130 extends axially into the first and second tongues 146a, 146b and is open to the first and second side grooves 144a, 144b. In the example illustrated, the first and second side grooves 144a, 144b pass axially through the end tongue 132, and axial end portions of the first and second side tongues 146a, 146b define laterally outer end portions of the end tongue 132.

A method of manufacturing the boards 102 includes cutting along the first side edge 114 of the board 102 to form the first side joint profile 116 and along the second side edge 118 of the board 102 to form the second side joint profile 120, and cutting along the first end edge 122 of the board 102 to form the first end joint profile 124 and along the second end edge 126 of the board 102 to form the second end joint profile 128. In the example illustrated, the first and second side joint profiles 116, 120 are cut into the first and second side edges 114, 118 using one or more rotary cutters (e.g. a pair of identical lock miter bits oriented at 90 degrees relative to each other), and the first and second end joint profiles 124, 128 are cut into the first and second end edges 122, 126 using one or more rotary cutters (e.g. a tongue bit and a corresponding groove bit). In the example illustrated, the first and second side joint profiles 116, 120 are cut prior to cutting the first and second end joint profiles 124, 128, and cutting the first and second end joint profiles 124, 128 includes cutting through axially opposite end portions of the first and second side joint profiles 116, 120.

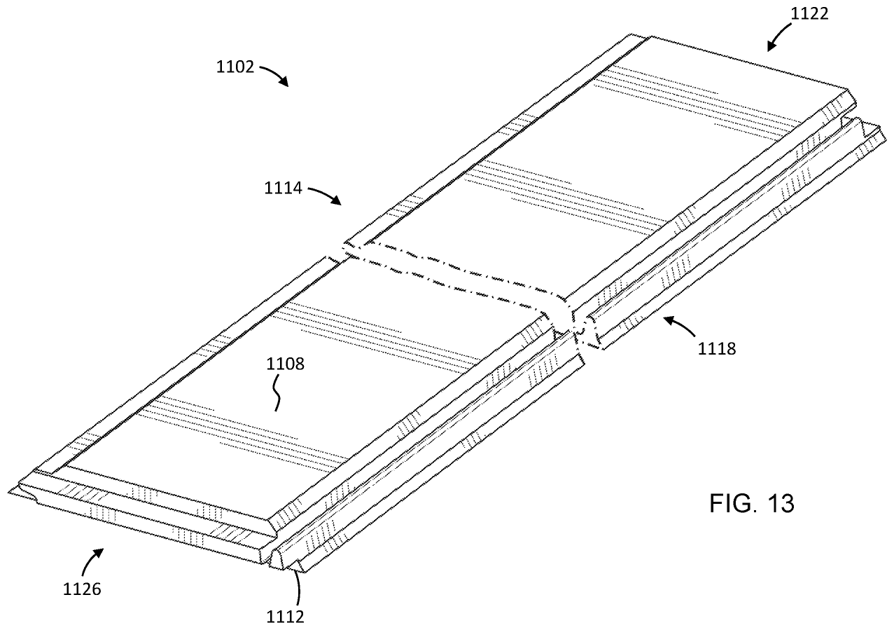

Referring to FIG. 13, another example interlockable board 1102 is illustrated. A plurality of the boards 1102 are usable together to form a multipurpose interlockable board system like that described herein with reference to the system 100. The board 1102 has similarities to the board 102, and like features are indicated using like reference characters, incremented by 1000.

In the example illustrated, each board 1102 has a board first face 1108 and an opposite board second face 1112. The board first and second faces 1108, 1112 extend axially between first and second end edges 1122, 1126 and laterally between first and second side edges 1114, 1118 of the board 1102.

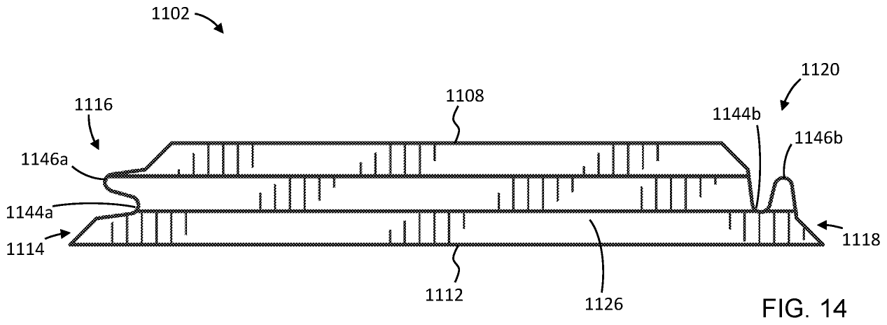

Referring to FIG. 14, in the example illustrated, an interlockable first side joint profile 1116 extends along the first side edge 1114 and a complementary interlockable second side joint profile 1120 extends along the second side edge 1118. In the example illustrated, the first side joint profile 1116 comprises a first side groove 1144a and a first side tongue 1146a adjoining the first side groove 1144a. When the board 1102 is viewed from the end edge (1122 or 1126), the innermost end of the first side groove 1144a and the tip of the first side tongue 1146a have rounded profiles defined by complementary radii. The second side joint profile 1120 comprises a second side groove 1144b and a second side tongue 1146b adjoining the second side groove 1144b. When the board 1102 is viewed from the end edge (1122 or 1126), the innermost end of the second side groove 1144b and the tip of the second side tongue 1146b have rounded profiles defined by complementary radii.

1. A multipurpose interlockable board system comprising a plurality of identical interlockable boards, each board comprising:
a) a board first face and a board second face parallel to the board first face and spaced apart from the board first face by a board thickness, the board first and second faces extending axially along a board axis between first and second end edges of the board and extending laterally between first and second side edges of the board;
b) an interlockable first side joint profile extending along the first side edge;
c) an interlockable second side joint profile extending along the second side edge, each of the first and second side joint profiles of each board interlockable with each of the first and second side joint profiles of another board for interlocking laterally adjacent boards in a coplanar arrangement in which the boards are generally coplanar for selectively forming a flat covering, and in an orthogonal arrangement in which laterally adjacent boards are generally perpendicular for selectively forming a hollow section;
d) an interlockable first end joint profile extending along the first end edge; and
e) an interlockable second end joint profile extending along the second end edge, the second end joint profile of each board interlockable with the first end joint profile of another board for interlocking axially adjacent boards end-to-end to lengthen the flat covering and the hollow section selectively formed by the boards.

2. The board system of claim 1, wherein the board has four corners where corresponding end joint profiles and edge joint profiles intersect.

3. The board system of claim 1, wherein each of the first and second end joint profiles extends generally continuously from the first side edge to the second side edge of the board, and each of the first and second side joint profiles extends generally continuously from the first end edge to the second end edge of the board.

4. The board system of claim 1, wherein each board is of integral, unitary, one-piece construction.

5. The board system of claim 1, wherein the board is made of solid wood, and each of the first and second side joint profiles and the first and second end joint profiles are cut into the solid wood.

6. The board system of claim 1, wherein the first end joint profile comprises an end groove extending axially into the first end edge and laterally between the first and second side edges, and the second end joint profile comprises an end tongue projecting axially from the second end edge and extending laterally between the first and second side edges.

7. The board system of claim 6, wherein the end groove is disposed orthogonally between a pair of axially extending first and second flanges, the first flange having a first flange outer surface defined by part of the board first face and a first flange inner surface opposite the first flange, and the second flange having a second flange outer surface defined by part of the board second face and a second flange inner surface opposite the second flange outer surface and facing the first flange inner surface, and wherein the end groove is bounded orthogonally by the first and second flange inner surfaces.

8. The board system of claim 7, wherein the second end joint profile includes a first end recess adjacent the end tongue and open orthogonally to the first face and a second end recess adjacent the end tongue opposite the first end recess and open orthogonally to the board second face, and wherein when axially adjacent boards are interlocked end-to-end, the first and second end recesses of one board of the axially adjacent boards receive the first and second flanges, respectively, of another board of the axially adjacent boards.

9. The board system of claim 1, wherein the laterally adjacent boards are interlockable in a first side-by-side coplanar arrangement along respective first sides thereof by interlocking together the first side joint profiles of each board of the laterally adjacent boards, and are interlockable in a second side-by-side coplanar arrangement along respective second sides thereof by interlocking together the second side joint profiles of each board of the laterally adjacent boards.

10. The board system of claim 9, wherein the laterally adjacent boards are interlockable in the orthogonal arrangement along respective sides thereof by interlocking together the first side joint profile of one board of the laterally adjacent boards with the second side joint profile of another board of the laterally adjacent boards.

11. The board system of claim 1, wherein the first side joint profile defines a first lock miter profile and the second side joint profile defines a second lock miter profile, the first and second lock miter profiles corresponding in shape and size for interlocking thereof and oriented perpendicular to each other.

12. The board system of claim 1, wherein each of the first side joint profile and the second side joint profile comprises a 45-degree bevel surface sloping laterally inwardly from the second face to the first face, a side groove in the bevel surface, and a side tongue adjoining the side groove and projecting from the bevel surface, wherein the side tongue and groove of the first side joint profile are oriented parallel to the first and second faces, and the side tongue and groove of the second side joint profile are oriented perpendicular to the first and second faces, and each side tongue and groove of the board is interlockable with each side tongue and groove of another board.

13. The board system of claim 1, wherein the first side joint profile comprises a first side groove disposed between a laterally protruding side flange and a laterally protruding first side tongue, the side flange having a side flange outer surface defined by part of the board second face and a side flange inner surface orthogonally opposite the side flange outer surface and bounding the first side groove, and the first side tongue protruding laterally outwardly and disposed orthogonally intermediate the first side groove and the board first face, and wherein laterally adjacent boards are interlockable in a first side-by-side coplanar arrangement, in which the first side tongue of each board of the laterally adjacent boards is received in a corresponding first side groove of another board of the laterally adjacent boards.

14. The board system of claim 13, wherein the first side joint profile includes a side recess adjacent the first side tongue opposite the first side groove and open orthogonally to the board first face, and wherein when laterally adjacent boards are interlocked in the first side-by-side coplanar arrangement, the side flange of each board of the laterally adjacent boards is received in a corresponding side recess of another board of the laterally adjacent boards.

15. The board system of claim 14, wherein the second side joint profile comprises a second side groove open orthogonally to the first face and a second side tongue laterally outboard of the first side groove and projecting orthogonally toward the first face, and wherein laterally adjacent boards are interlockable in a second side-by-side coplanar arrangement, in which the second side tongue of each board of the laterally adjacent boards is received in a corresponding second side groove of another board of the laterally adjacent boards.

16. The board system of claim 15, wherein when laterally adjacent boards are interlocked in the orthogonal arrangement, the first side tongue of a first board of the laterally adjacent boards is received in the second side groove of a second board of the laterally adjacent boards, and the second side tongue of the second board is received in the first side groove of the first board.

17. A multipurpose interlockable board system comprising a plurality of identical boards interlockable in a coplanar arrangement in which laterally adjacent boards are generally coplanar for selectively forming a flat covering and in an orthogonal arrangement in which laterally adjacent boards are generally perpendicular for selectively forming a hollow section, and the boards interlockable end-to-end to lengthen the flat covering and the hollow section selectively formed by the boards.

18. The board system of claim 17, wherein each board has interlockable side joint profiles along laterally opposing edges of the board for interlocking the boards in the coplanar arrangement and in the orthogonal arrangement, and interlockable end joint profiles along axially opposite ends of the board for interlocking the boards end-to-end.

19. The board system of claim 18, wherein the boards are made entirely of solid wood, and wherein the side joint profiles and the end joint profiles are cut into the solid wood.

20. A method of manufacturing an interlockable board for a multipurpose interlockable board system, comprising:
a) cutting a first side joint profile along a first side edge of the board and a complementary second side joint profile along a second side edge of the board laterally opposite the first side edge, each of the first and second side joint profiles of the board interlockable with each of the first and second side joint profiles of another board for interlocking laterally adjacent boards in a coplanar arrangement in which the boards are generally coplanar for selectively forming a flat covering, and in an orthogonal arrangement in which laterally adjacent boards are generally perpendicular for selectively forming a hollow section; and
b) cutting a first end joint profile along a first end edge of the board and a complementary second end edge joint profile along a second end edge of the board axially opposite the first end edge, the second end joint profile of the board interlockable with the first end joint profile of another identical board for interlocking axially adjacent boards end-to-end to lengthen the flat covering and the hollow section selectively formed by the boards.
